(19) United States
(12) Patent Application Publication
(10) Pub. No.: US 2025/0296235 A1
(43) Pub. Date: Sep. 25, 2025

(54) ROBOTIC END EFFECTOR WITH TACTILE SENSING

(71) Applicant: Boston Dynamics, Inc., Waltham, MA (US)

(72) Inventors: Ian Taylor, Cambridge, MA (US); Alberto Rodriguez, Cambridge, MA (US)

(21) Appl. No.: 19/086,243

(22) Filed: Mar. 21, 2025

Related U.S. Application Data
(60) Provisional application No. 63/568,562, filed on Mar. 22, 2024.

(51) Int. Cl. B25J 9/16; B25J 15/10; B25J 19/02

(52) U.S. Cl. CPC B25J 9/1694; B25J 15/10; B25J 19/02

(57) ABSTRACT

A sensor module for an end effector of a robot is described. The sensor module includes a substrate having formed thereon, a set of proximity sensors and a set of pressure sensors, the set of proximity sensors and the set of pressure sensors configured to have overlapping sensing regions, and a cover coupled to the substrate, the cover comprising a material that permits transmission of signals from the set of proximity sensors through the material.

### CROSS-REFERENCE TO RELATED APPLICATIONS

This application claims the benefit of priority under 35 U.S.C. § 119 (e) to U.S. Provisional Application Ser. No. 63/568,562, entitled “ROBOTIC END EFFECTOR WITH TACTILE SENSING,” filed Mar. 22, 2024, the entire contents of which is incorporated herein by reference.

### FIELD OF THE INVENTION

This disclosure relates generally to robotics and more specifically to systems, methods and apparatuses for providing sensing functionality to a robotic end effector.

### BACKGROUND

A robot is generally defined as a reprogrammable and multifunctional manipulator designed to move material, parts, tools, and/or specialized devices (e.g., via variable programmed motions) for performing tasks. Robots may include manipulators that are physically anchored (e.g., industrial robotic arms), mobile devices that move throughout an environment (e.g., using legs, wheels, or traction-based mechanisms), or some combination of one or more manipulators and one or more mobile devices. Robots are currently used in a variety of industries, including, for example, manufacturing, warehouse logistics, transportation, hazardous environments, exploration, and healthcare.

### SUMMARY

A variety of settings today demand high levels of automation, e.g., factories, transportation facilities, material handling facilities and warehouses, among others. One exemplary task that it is desirable to automate is pick-and-place operations (e.g., moving a variety of parts from and/or into containers), but automating this task comes with challenges. For example, to perform a successful pick-and-place operation, a robot should securely grasp an object and maintain the secure grasp throughout the operation. The robot may include a perception system (e.g., one or more cameras), which may be used to determine a suitable region on the object for grasping by an end effector (e.g. a gripper) of the robot. However, noise in the system (e.g., miscalibration in the perception system, miscalibration in the control system of the robot, etc.) may result in a misalignment between the end effector position and the location of the object when the robot attempts to grasp the object. A tactile sensor is a device that measures information arising from the physical interaction with the sensor's environment. For instance, tactile sensing may mimic or be modeled after receptors in human skin that sense physical touch. Some embodiments of the present disclosure enable more reliable grasping of objects by providing tactile sensing functionality to an end effector of a robot. For example, tactile sensors arranged near the grasping surface may provide feedback to the robot's control system to adjust a grasp pose of the end effector of the robot as needed to execute a secure grasp of the object. Additionally, manipulating an object once grasped by a robotic end effector may be challenging without contact feedback provided at the level of the end effector. Some embodiments of the present disclosure facilitate “dynamic grasping” of an object by using tactile sensing to monitor and provide feedback to a control system of a robot during manipulation of the object.

The present invention includes systems, methods and apparatuses for providing tactile sensing functionality to robotic end effectors. In one illustrative embodiment, a robotic end effector comprises a gripper having a set (e.g., one, two, three, four, five, or a different number) of fingers, with each finger having two independently actuated phalanges. Each of the fingers may also include a tactile sensor configured to sense a distance to an object (e.g., prior to contact with the object) and contact forces applied by the object on the sensor (e.g., during contact with the object). However, one having ordinary skill in the art will readily appreciate that a variety of other implementations are possible without departing from the spirit and scope of the invention.

In some embodiments, the invention features a sensor module for an end effector of a robot. The sensor module includes a substrate having formed thereon, a set of proximity sensors and a set of pressure sensors, the set of proximity sensors and the set of pressure sensors configured to have overlapping sensing regions, and a cover coupled to the substrate, the cover comprising a material that permits transmission of signals from the set of proximity sensors through the material.

In one aspect, the sensor module further includes a rigid structure formed between the substrate and the cover. In another aspect, the rigid structure comprises a plate having holes formed therein for the set of proximity sensors and the set of pressure sensors. In another aspect, the rigid structure comprises a metal structure. In another aspect, at least a portion of the cover is mechanically coupled to the substrate. In another aspect, the at least a portion of the cover wraps around an edge of the substrate. In another aspect, the cover comprises an elastomer. In another aspect, the set of proximity sensors comprises at least one time-of-flight sensor. In another aspect, the set of proximity sensors comprises at least one radar sensor. In another aspect, the set of pressure sensors comprises a set of barometric transducers. In another aspect, the set of proximity sensors includes a single proximity sensor, and the set of pressure sensors includes at least four pressure sensors arranged adjacent to the single proximity sensor. In another aspect, the set of pressure sensors includes at least eight pressure sensors. In another aspect, the set of pressure sensors is configured to provide a distribution of contact pressure on the cover when in contact with an object. In another aspect, the set of pressure sensors is configured to sense contact data at a rate of at least 200 Hz. In another aspect, the set of proximity sensors is configured to sense distance data at a rate of at least 100 Hz. In another aspect, the sensor module further includes a component configured to combine contact data from the set of pressure sensors and distance data from the set of proximity sensors to produce a single data stream. In another aspect, the substrate comprises a printed circuit board.

In another aspect, the set of proximity sensors is configured to project optical signals, and the cover comprises an optically translucent material. In another aspect, the set of proximity sensors is configured to project acoustic signals, and the cover comprises an acoustically transparent material. In another aspect, the set of proximity sensors is configured to project electromagnetic signals, and the cover comprises a non-conductive material. In another aspect, the set of proximity sensors comprises a single proximity sensor, and the set of pressure sensors includes at least three pressure sensors arranged adjacent to the single proximity sensor. In another aspect, a dynamic range of each pressure sensor in the set of pressure sensors is 1-300N.

In some embodiments, the invention features an apparatus for a robot. The apparatus includes a base, and at least two modules coupled to the base. Each module includes a proximal link and a distal link coupled to the proximal link. Each of the distal links includes a sensor module. The sensor module includes a substrate having formed thereon, a set of proximity sensors and a set of pressure sensors, the set of proximity sensors and the set of pressure sensors configured to have overlapping sensing regions, and a cover coupled to the substrate, the cover comprising a material that permits transmission of signals from the set of proximity sensors through the material.

In one aspect, the sensor module further includes a rigid structure formed between the substrate and the cover. In another aspect, the rigid structure comprises a plate having holes formed therein for the set of proximity sensors and the set of pressure sensors. In another aspect, the rigid structure comprises a metal structure. In another aspect, at least a portion of the cover wraps around an edge of the substrate. In another aspect, the cover comprises an elastomer. In another aspect, the set of proximity sensors comprises at least one time-of-flight sensor. In another aspect, the set of proximity sensors comprises at least one radar sensor. In another aspect, the set of pressure sensors comprises a set of barometric transducers. In another aspect, the set of proximity sensors includes a single proximity sensor, and the set of pressure sensors includes at least four pressure sensors arranged adjacent to the single proximity sensor. In another aspect, the set of pressure sensors includes at least eight pressure sensors. In another aspect, the set of pressure sensors is configured to provide a distribution of contact pressure on the cover when in contact with an object. In another aspect, the set of pressure sensors is configured to sense contact data at a rate of at least 200 Hz. In another aspect, the set of proximity sensors is configured to sense distance data at a rate of at least 100 Hz. In another aspect, the sensor module further comprises a component configured to combine contact data from the set of pressure sensors and distance data from the set of proximity sensors to produce a single data stream. In another aspect, the substrate comprises a printed circuit board.

In another aspect, the set of proximity sensors is configured to project optical signals, and the cover comprises an optically translucent material. In another aspect, the set of proximity sensors is configured to project acoustic signals, and the cover comprises an acoustically transparent material. In another aspect, the set of proximity sensors is configured to project electromagnetic signals, and the cover comprises a non-conductive material. In another aspect, the set of proximity sensors comprises a single proximity sensor, and the set of pressure sensors includes at least three pressure sensors arranged adjacent to the single proximity sensor. In another aspect, a dynamic range of each pressure sensor in the set of pressure sensors is 1-300N.

In another aspect, the at least two modules includes at least three modules. In another aspect, a first module of at least one of the at least three modules is configured to rotate into an opposed configuration with respect to a second module of the at least three modules, in the opposed configuration the sensor module of the first module and the sensor module of the second module face each other. In another aspect, the apparatus is a robotic end effector.

In some embodiments, the invention features a method of grasping an object with a robotic end effector. The method includes receiving distance data from a set of proximity sensors mounted on the robotic end effector, wherein the distance data indicates a distance between the set of proximity sensors and the object, controlling the robotic end effector to approach the object based, at least in part, on the received distance data, receiving contact data from a set of pressure sensors mounted on the robotic end effector, the set of pressure sensors configured to have an overlapping sensing region with the set of proximity sensors, and controlling the robotic end effector to grasp the object based, at least in part, on the received contact data.

In one aspect, the distance data is received prior to contact with the object. In another aspect, the contact data is received after contact with the object. In another aspect, the set of proximity sensors includes at least one time-of-flight sensor, and the method further includes projecting an optical signal from the set of proximity sensors, and receiving distance data includes receiving signals reflected from the object in response to projecting the optical signal. In another aspect, the set of proximity sensors and the set of pressure sensors have overlapping sensing fields. In another aspect, the method further includes determining, based on the contact data, a distribution of contact pressure on a cover formed over the set of pressure sensors, and controlling the robotic end effector to grasp the object based, at least in part, on the received contact data includes controlling the robotic end effector to grasp the object based, at least in part, on the distribution of contact pressure on the cover. In another aspect, receiving contact data includes receiving the contact data at a rate of at least 200 Hz. In another aspect, receiving distance data includes receiving distance data at a rate of at least 100 Hz. In another aspect, the method further includes combining the contact data and the distance data to produce a single data stream.

In some embodiments, the invention features a method of manipulating a grasped object. The method includes receiving first tactile sensor data from a first tactile sensor arranged on a first link of a first robotic end effector of a robot, wherein the first tactile sensor data includes first contact data describing a force applied to the first tactile sensor from a grasped object, and adjusting a grasp on the grasped object based, at least in part, on an object manipulation objective and the first tactile sensor data.

In one aspect, the force applied to the first tactile sensor is a force distribution applied to a surface of the first tactile sensor. In another aspect, the method further includes receiving second tactile sensor data from a second tactile sensor arranged on a second link of the first robotic end effector, wherein the second tactile sensor data includes second contact data describing a force applied to the second tactile sensor from the grasped object or distance data indicating a distance from the second tactile sensor to the grasped object, and adjusting the grasp on the grasped object is further based, at least in part, on the second tactile sensor data. In another aspect, the force applied to the second tactile sensor is a force distribution applied to a surface of the second tactile sensor.

In another aspect, the method further includes receiving second tactile sensor data from a second tactile sensor arranged on a first link of a second robotic end effector, wherein the second tactile sensor data includes second contact data describing a force applied to the second tactile sensor from the grasped object or distance data indicating a distance from the second tactile sensor to the grasped object, and adjusting the grasp on the grasped object is further based, at least in part, on the second tactile sensor data. In another aspect, the object manipulation objective includes shifting a position of the grasped object within the first robotic end effector. In another aspect, the object manipulation objective includes transferring the grasped object from the first robotic end effector to a second robotic end effector. In another aspect, the object manipulation objective includes coordinating the grasp between the first robotic end effector and a second robotic end effector in contact with the grasped object. In another aspect, the object manipulation objective includes lifting the grasped object. In another aspect, the object manipulation objective includes releasing the grasp of the grasped object. In another aspect, the object manipulation objective includes placing the grasped object in a particular location. In another aspect, receiving first tactile sensor data comprises continuously receiving first tactile sensor data during adjusting of the grasp.

### BRIEF DESCRIPTION OF DRAWINGS

The advantages of the invention, together with further advantages, may be better understood by referring to the following description taken in conjunction with the accompanying drawings. The drawings are not necessarily to scale, and emphasis is instead generally placed upon illustrating the principles of the invention.

FIG. 1A illustrates an example configuration of a robotic device, according to an illustrative embodiment of the invention.

FIG. 1B illustrates an example configuration of a robotic device coupled to a robotic end effector, according to an illustrative embodiment of the invention.

FIG. 2A illustrates an example of a humanoid robot, according to an illustrative embodiment of the invention.

FIG. 2B illustrates an example of a humanoid robot having two robotic end effectors, according to an illustrative embodiment of the invention.

FIG. 3 is a schematic illustration of an example robotic end effector including a tactile sensor, according to an illustrative embodiment of the invention.

FIGS. 4A, 4B, and 4C are respective top, side, and isometric views of a tactile sensor arranged on a distal link of a robotic end effector, according to an illustrative embodiment of the invention.

FIG. 5A is an exploded view of a tactile sensor, according to an illustrative embodiment of the invention.

FIGS. 5B, 5C and 5D are respective top, side, and bottom views of an assembled tactile sensor, according to an illustrative embodiment of the invention.

FIG. 6A is a top view of a tactile sensor arranged on a distal link of a robotic end effector, according to an illustrative embodiment of the invention.

FIG. 6B is a side transparent view of the tactile sensor shown in FIG. 6A.

FIG. 6C schematically illustrates a force distribution sensed on a surface of a tactile sensor, according to an illustrative embodiment of the invention.

FIG. 6D schematically illustrates a distance measurement sensed by a sensor module, according to an illustrative embodiment of the invention.

FIG. 7A is an isometric view of a tactile sensor arranged on a distal link of a robotic end effector, according to an illustrative embodiment of the invention.

FIG. 7B is an isometric transparent view of the tactile sensor shown in FIG. 7A.

FIG. 7C is a side transparent view of the tactile sensor shown in FIG. 7B.

FIG. 8 is a flowchart of an exemplary method, according to an illustrative embodiment of the invention.

FIG. 9 is a flowchart of another exemplary method, according to an illustrative embodiment of the invention.

### DETAILED DESCRIPTION

An example implementation involves a robotic device configured with at least one robotic limb, one or more sensors, and a processing system. The robotic limb may be an articulated robotic appendage including a number of members connected by joints. The robotic limb may also include a number of actuators (e.g., 2-5 actuators) coupled to the members of the limb that facilitate movement of the robotic limb through a range of motion limited by the joints connecting the members. The sensors may be configured to measure properties of the robotic device, such as angles of the joints, pressures within the actuators, joint torques, and/or positions, velocities, and/or accelerations of members of the robotic limb(s) at a given point in time. The sensors may also be configured to measure an orientation (e.g., a body orientation measurement) of the body of the robotic device (which may also be referred to herein as the “base” of the robotic device). Other example properties include the masses of various components of the robotic device, among other properties. The processing system of the robotic device may determine the angles of the joints of the robotic limb, either directly from angle sensor information or indirectly from other sensor information from which the joint angles can be calculated. The processing system may then estimate an orientation of the robotic device based on the sensed orientation of the base of the robotic device and the joint angles.

An orientation may herein refer to an angular position of an object. In some instances, an orientation may refer to an amount of rotation (e.g., in degrees or radians) about three axes. In some cases, an orientation of a robotic device may refer to the orientation of the robotic device with respect to a particular reference frame, such as the ground or a surface on which it stands. An orientation may describe the angular position using Euler angles, Tait-Bryan angles (also known as yaw, pitch, and roll angles), and/or Quaternions. In some instances, such as on a computer-readable medium, the orientation may be represented by an orientation matrix and/or an orientation quaternion, among other representations.

In some scenarios, measurements from sensors on the base of the robotic device may indicate that the robotic device is oriented in such a way and/or has a linear and/or angular velocity that requires control of one or more of the articulated appendages in order to maintain balance of the robotic device. In these scenarios, however, it may be the case that the limbs of the robotic device are oriented and/or moving such that balance control is not required. For example, the body of the robotic device may be tilted to the left, and sensors measuring the body's orientation may thus indicate a need to move limbs to balance the robotic device; however, one or more limbs of the robotic device may be extended to the right, causing the robotic device to be balanced despite the sensors on the base of the robotic device indicating otherwise. The limbs of a robotic device may apply a torque on the body of the robotic device and may also affect the robotic device's center of mass. Thus, orientation and angular velocity measurements of one portion of the robotic device may be an inaccurate representation of the orientation and angular velocity of the combination of the robotic device's body and limbs (which may be referred to herein as the “aggregate” orientation and angular velocity).

In some implementations, the processing system may be configured to estimate the aggregate orientation and/or angular velocity of the entire robotic device based on the sensed orientation of the base of the robotic device and the measured joint angles. The processing system has stored thereon a relationship between the joint angles of the robotic device and the extent to which the joint angles of the robotic device affect the orientation and/or angular velocity of the base of the robotic device. The relationship between the joint angles of the robotic device and the motion of the base of the robotic device may be determined based on the kinematics and mass properties of the limbs of the robotic devices. In other words, the relationship may specify the effects that the joint angles have on the aggregate orientation and/or angular velocity of the robotic device. Additionally, the processing system may be configured to determine components of the orientation and/or angular velocity of the robotic device caused by internal motion and components of the orientation and/or angular velocity of the robotic device caused by external motion. Further, the processing system may differentiate components of the aggregate orientation in order to determine the robotic device's aggregate yaw rate, pitch rate, and roll rate (which may be collectively referred to as the “aggregate angular velocity”).

In some implementations, the robotic device may also include a control system that is configured to control the robotic device on the basis of a simplified model of the robotic device. The control system may be configured to receive the estimated aggregate orientation and/or angular velocity of the robotic device, and subsequently control one or more jointed limbs of the robotic device to behave in a certain manner (e.g., maintain the balance of the robotic device). For instance, the control system may determine locations at which to place the robotic device's feet and/or the force to exert by the robotic device's feet on a surface based on the aggregate orientation.

In some implementations, the robotic device may include force sensors that measure or estimate the external forces (e.g., the force applied by a leg of the robotic device against the ground) along with kinematic sensors to measure the orientation of the limbs of the robotic device. The processing system may be configured to determine the robotic device's angular momentum based on information measured by the sensors. The control system may be configured with a feedback-based state observer that receives the measured angular momentum and the aggregate angular velocity, and provides a reduced-noise estimate of the angular momentum of the robotic device. The state observer may also receive measurements and/or estimates of torques or forces acting on the robotic device and use them, among other information, as a basis to determine the reduced-noise estimate of the angular momentum of the robotic device.

The control system may be configured to actuate one or more actuators connected across components of a robotic leg. The actuators may be controlled to raise or lower the robotic leg. In some cases, a robotic leg may include actuators to control the robotic leg's motion in three dimensions. Depending on the particular implementation, the control system may be configured to use the aggregate orientation, along with other sensor measurements, as a basis to control the robot in a certain manner (e.g., stationary balancing, walking, running, galloping, etc.).

In some implementations, multiple relationships between the joint angles and their effect on the orientation and/or angular velocity of the base of the robotic device may be stored on the processing system. The processing system may select a particular relationship with which to determine the aggregate orientation and/or angular velocity based on the joint angles. For example, one relationship may be associated with a particular joint being between 0 and 90 degrees, and another relationship may be associated with the particular joint being between 91 and 180 degrees. The selected relationship may more accurately estimate the aggregate orientation of the robotic device than the other relationships.

In some implementations, the processing system may have stored thereon more than one relationship between the joint angles of the robotic device and the extent to which the joint angles of the robotic device affect the orientation and/or angular velocity of the base of the robotic device. Each relationship may correspond to one or more ranges of joint angle values (e.g., operating ranges). In some implementations, the robotic device may operate in one or more modes. A mode of operation may correspond to one or more of the joint angles being within a corresponding set of operating ranges. In these implementations, each mode of operation may correspond to a certain relationship.

The angular velocity of the robotic device may have multiple components describing the robotic device's orientation (e.g., rotational angles) along multiple planes. From the perspective of the robotic device, a rotational angle of the robotic device turned to the left or the right may be referred to herein as “yaw.” A rotational angle of the robotic device upwards or downwards may be referred to herein as “pitch.” A rotational angle of the robotic device tilted to the left or the right may be referred to herein as “roll.” Additionally, the rate of change of the yaw, pitch, and roll may be referred to herein as the “yaw rate,” the “pitch rate,” and the “roll rate,” respectively.

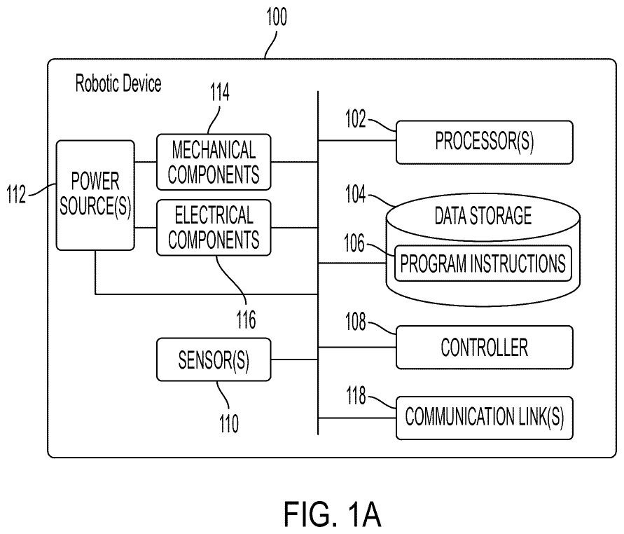

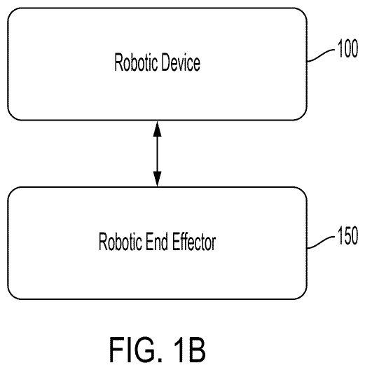

Referring now to the figures, FIG. 1A illustrates an example configuration of a robotic device (or “robot”) 100, according to an illustrative embodiment of the invention. The robotic device 100 represents an example robotic device configured to perform the operations described herein. Additionally, the robotic device 100 may be configured to operate autonomously, semi-autonomously, and/or using directions provided by user(s), and may exist in various forms, such as a humanoid robot, biped, quadruped, or other mobile robot, among other examples. Furthermore, the robotic device 100 may also be referred to as a robotic system, mobile robot, or robot, among other designations.

As shown in FIG. 1A, the robotic device 100 includes processor(s) 102, data storage 104, program instructions 106, controller 108, sensor(s) 110, power source(s) 112, mechanical components 114, and electrical components 116. The robotic device 100 is shown for illustration purposes and may include more or fewer components without departing from the scope of the disclosure herein. The various components of robotic device 100 may be connected in any manner, including via electronic communication means, e.g., wired or wireless connections. Further, in some examples, components of the robotic device 100 may be positioned on multiple distinct physical entities rather on a single physical entity. Other example illustrations of robotic device 100 may exist as well.

Processor(s) 102 may operate as one or more general-purpose processor or special purpose processors (e.g., digital signal processors, application specific integrated circuits, etc.). The processor(s) 102 can be configured to execute computer-readable program instructions 106 that are stored in the data storage 104 and are executable to provide the operations of the robotic device 100 described herein. For instance, the program instructions 106 may be executable to provide operations of controller 108, where the controller 108 may be configured to cause activation and/or deactivation of the mechanical components 114 and the electrical components 116. The processor(s) 102 may operate and enable the robotic device 100 to perform various functions, including the functions described herein.

The data storage 104 may exist as various types of storage media, such as a memory. For example, the data storage 104 may include or take the form of one or more computer-readable storage media that can be read or accessed by processor(s) 102. The one or more computer-readable storage media can include volatile and/or non-volatile storage components, such as optical, magnetic, organic or other memory or disc storage, which can be integrated in whole or in part with processor(s) 102. In some implementations, the data storage 104 can be implemented using a single physical device (e.g., one optical, magnetic, organic or other memory or disc storage unit), while in other implementations, the data storage 104 can be implemented using two or more physical devices, which may communicate electronically (e.g., via wired or wireless communication). Further, in addition to the computer-readable program instructions 106, the data storage 104 may include additional data such as diagnostic data, among other possibilities.

The robotic device 100 may include at least one controller 108, which may interface with the robotic device 100. The controller 108 may serve as a link between portions of the robotic device 100, such as a link between mechanical components 114 and/or electrical components 116. In some instances, the controller 108 may serve as an interface between the robotic device 100 and another computing device. Furthermore, the controller 108 may serve as an interface between the robotic device 100 and a user(s). The controller 108 may include various components for communicating with the robotic device 100, including one or more joysticks or buttons, among other features. The controller 108 may perform other operations for the robotic device 100 as well. Other examples of controllers may exist as well.

Additionally, the robotic device 100 includes one or more sensor(s) 110 such as force sensors, proximity sensors, motion sensors, load sensors, position sensors, touch sensors, depth sensors, ultrasonic range sensors, and/or infrared sensors, among other possibilities. The sensor(s) 110 may provide sensor data to the processor(s) 102 to allow for appropriate interaction of the robotic device 100 with the environment as well as monitoring of operation of the systems of the robotic device 100. The sensor data may be used in evaluation of various factors for activation and deactivation of mechanical components 114 and electrical components 116 by controller 108 and/or a computing system of the robotic device 100.

The sensor(s) 110 may provide information indicative of the environment of the robotic device for the controller 108 and/or computing system to use to determine operations for the robotic device 100. For example, the sensor(s) 110 may capture data corresponding to the terrain of the environment or location of nearby objects, which may assist with environment recognition and navigation, etc. In an example configuration, the robotic device 100 may include a sensor system that may include a camera, RADAR, LIDAR, time-of-flight camera, global positioning system (GPS) transceiver, and/or other sensors for capturing information of the environment of the robotic device 100. The sensor(s) 110 may monitor the environment in real-time and detect obstacles, elements of the terrain, weather conditions, temperature, and/or other parameters of the environment for the robotic device 100.

Further, the robotic device 100 may include other sensor(s) 110 configured to receive information indicative of the state of the robotic device 100, including sensor(s) 110 that may monitor the state of the various components of the robotic device 100. The sensor(s) 110 may measure activity of systems of the robotic device 100 and receive information based on the operation of the various features of the robotic device 100, such the operation of extendable legs, arms, or other mechanical and/or electrical features of the robotic device 100. The sensor data provided by the sensors may enable the computing system of the robotic device 100 to determine errors in operation as well as monitor overall functioning of components of the robotic device 100.

For example, the computing system may use sensor data to determine the stability of the robotic device 100 during operations as well as measurements related to power levels, communication activities, components that require repair, among other information. As an example configuration, the robotic device 100 may include gyroscope(s), accelerometer(s), and/or other possible sensors to provide sensor data relating to the state of operation of the robotic device. Further, sensor(s) 110 may also monitor the current state of a function, such as a gait, that the robotic device 100 may currently be operating. Additionally, the sensor(s) 110 may measure a distance between a given robotic leg of a robotic device and a center of mass of the robotic device. Other example uses for the sensor(s) 110 may exist as well.

Additionally, the robotic device 100 may also include one or more power source(s) 112 configured to supply power to various components of the robotic device 100. Among possible power systems, the robotic device 100 may include a hydraulic system, electrical system, batteries, and/or other types of power systems. As an example illustration, the robotic device 100 may include one or more batteries configured to provide power to components via a wired and/or wireless connection. Within examples, components of the mechanical components 114 and electrical components 116 may each connect to a different power source or may be powered by the same power source. Components of the robotic device 100 may connect to multiple power sources as well.

Within example configurations, any type of power source may be used to power the robotic device 100, such as a gasoline and/or electric engine. Further, the power source(s) 112 may charge using various types of charging, such as wired connections to an outside power source, wireless charging, combustion, or other examples. Other configurations may also be possible. Additionally, the robotic device 100 may include a hydraulic system configured to provide power to the mechanical components 114 using fluid power. Components of the robotic device 100 may operate based on hydraulic fluid being transmitted throughout the hydraulic system to various hydraulic motors and hydraulic cylinders, for example. The hydraulic system of the robotic device 100 may transfer a large amount of power through small tubes, flexible hoses, or other links between components of the robotic device 100. Other power sources may be included within the robotic device 100.

Mechanical components 114 can represent hardware of the robotic device 100 that may enable the robotic device 100 to operate and perform physical functions. As a few examples, the robotic device 100 may include actuator(s), extendable leg(s) (“legs”), arm(s), wheel(s), one or multiple structured bodies for housing the computing system or other components, and/or other mechanical components. The mechanical components 114 may depend on the design of the robotic device 100 and may also be based on the functions and/or tasks the robotic device 100 may be configured to perform. As such, depending on the operation and functions of the robotic device 100, different mechanical components 114 may be available for the robotic device 100 to utilize. In some examples, the robotic device 100 may be configured to add and/or remove mechanical components 114, which may involve assistance from a user and/or other robotic device. For example, the robotic device 100 may be initially configured with four legs, but may be altered by a user or the robotic device 100 to remove two of the four legs to operate as a biped. Other examples of mechanical components 114 may be included.

The electrical components 116 may include various components capable of processing, transferring, providing electrical charge or electric signals, for example. Among possible examples, the electrical components 116 may include electrical wires, circuitry, and/or wireless communication transmitters and receivers to enable operations of the robotic device 100. The electrical components 116 may interwork with the mechanical components 114 to enable the robotic device 100 to perform various operations. The electrical components 116 may be configured to provide power from the power source(s) 112 to the various mechanical components 114, for example. Further, the robotic device 100 may include electric motors. Other examples of electrical components 116 may exist as well.

In some implementations, the robotic device 100 may also include communication link(s) 118 configured to send and/or receive information. The communication link(s) 118 may transmit data indicating the state of the various components of the robotic device 100. For example, information read in by sensor(s) 110 may be transmitted via the communication link(s) 118 to a separate device. Other diagnostic information indicating the integrity or health of the power source(s) 112, mechanical components 114, electrical components 116, processor(s) 102, data storage 104, and/or controller 108 may be transmitted via the communication link(s) 118 to an external communication device.

In some implementations, the robotic device 100 may receive information at the communication link(s) 118 that is processed by the processor(s) 102. The received information may indicate data that is accessible by the processor(s) 102 during execution of the program instructions 106, for example. Further, the received information may change aspects of the controller 108 that may affect the behavior of the mechanical components 114 or the electrical components 116. In some cases, the received information indicates a query requesting a particular piece of information (e.g., the operational state of one or more of the components of the robotic device 100), and the processor(s) 102 may subsequently transmit that particular piece of information back out the communication link(s) 118.

In some cases, the communication link(s) 118 include a wired connection. The robotic device 100 may include one or more ports to interface the communication link(s) 118 to an external device. The communication link(s) 118 may include, in addition to or alternatively to the wired connection, a wireless connection. Some example wireless connections may utilize a cellular connection, such as CDMA, EVDO, GSM/GPRS, or 4G telecommunication, such as WiMAX or LTE.

Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

FIG. 1B illustrates an example configuration of a robotic device 100 (e.g., as shown in FIG. 1A above) coupled to a robotic end effector 150, according to an illustrative embodiment of the invention. The robotic end effector 150 may be coupled to the robotic device 100 mechanically (e.g., may be physically mounted), electrically (e.g., may be wired), and/or communicatively (e.g., may communicate electronically with the robotic device 100). In some embodiments, the robotic end effector 150 can receive power from the robotic device 100 and/or control instructions from the robotic device 100 and/or an operator of the robotic device 100. In some embodiments, the robotic end effector 150 comprises electronic circuitry for control, power, and/or communications for the robotic end effector 150. In some embodiments, the robotic end effector 150 is detachable from the robotic device 100.

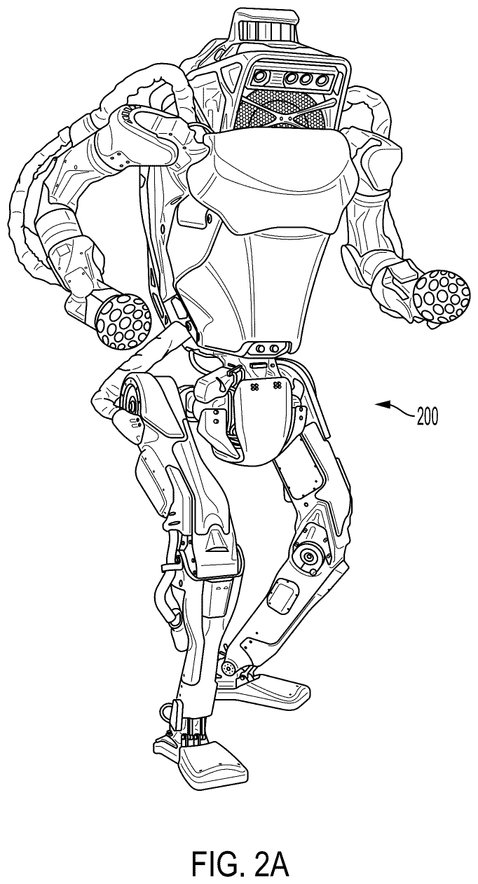

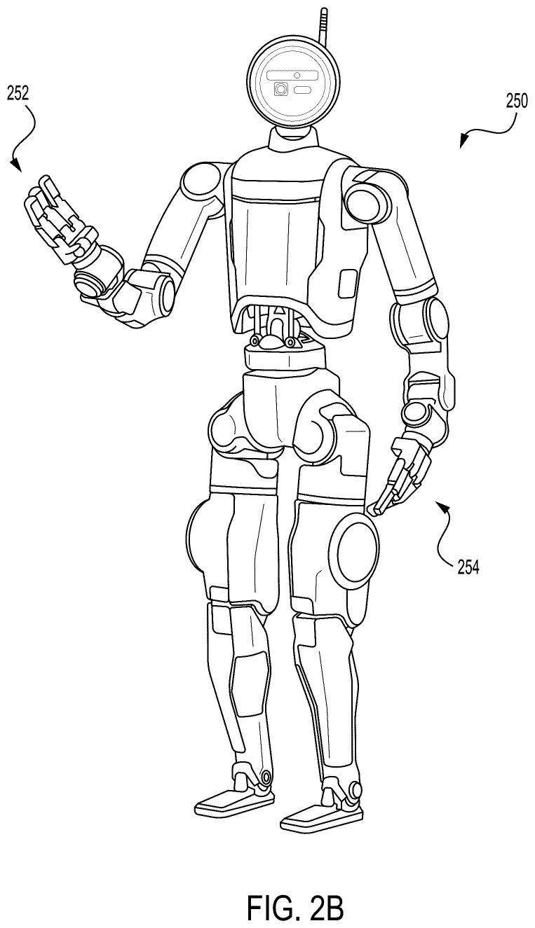

FIG. 2A illustrates an example of a humanoid robot, according to an illustrative embodiment of the invention. The robotic device 200 may correspond to the robotic device 100 shown in FIG. 1A. The robotic device 200 serves as a possible implementation of a robotic device that may be configured to include the systems and/or carry out the methods described herein. Other example implementations of robotic devices may exist.

The robotic device 200 may include a number of articulated appendages, such as robotic legs and/or robotic arms. Each articulated appendage may include a number of members connected by joints that allow the articulated appendage to move through certain degrees of freedom. Each member of an articulated appendage may have properties describing aspects of the member, such as its weight, weight distribution, length, and/or shape, among other properties. Similarly, each joint connecting the members of an articulated appendage may have known properties, such as the degrees of its range of motion the joint allows, the size of the joint, and the distance between members connected by the joint, among other properties. A given joint may be a joint allowing one degree of freedom (e.g., a knuckle joint or a hinge joint), a joint allowing two degrees of freedom (e.g., a cylindrical joint), a joint allowing three degrees of freedom (e.g., a ball and socket joint), or a joint allowing four or more degrees of freedom. A degree of freedom may refer to the ability of a member connected to a joint to move about a particular translational or rotational axis.

The robotic device 200 may also include sensors to measure the angles of the joints of its articulated appendages. In addition, the articulated appendages may include a number of actuators that can be controlled to extend and retract members of the articulated appendages. In some cases, the angle of a joint may be determined based on the extent of protrusion or retraction of a given actuator. In some instances, the joint angles may be inferred from position data of inertial measurement units (IMUs) mounted on the members of an articulated appendage. In some implementations, the joint angles may be measured using rotary position sensors, such as rotary encoders. In other implementations, the joint angles may be measured using optical reflection techniques. Other joint angle measurement techniques may also be used.

The robotic device 200 may be configured to send sensor data from the articulated appendages to a device coupled to the robotic device 200 such as a processing system, a computing system, or a control system. The robotic device 200 may include a memory, either included in a device on the robotic device 200 or as a standalone component, on which sensor data is stored. In some implementations, the sensor data is retained in the memory for a certain amount of time. In some cases, the stored sensor data may be processed or otherwise transformed for use by a control system on the robotic device 200. In some cases, the robotic device 200 may also transmit the sensor data over a wired or wireless connection (or other electronic communication means) to an external device.

FIG. 2B illustrates an example of a humanoid robot 250 having two robotic end effectors 252, 254, according to an illustrative embodiment of the invention. In FIG. 2B, the robotic end effectors 252, 254 are connected to the humanoid robot 250 (e.g., mechanically, electrically, and/or communicatively) and function as the “hands” of the humanoid form shown. Each robotic end effector 252, 254 can function as described in greater detail below.

Robotic end effectors (robotic end effectors 252, 254) of a robot (e.g., humanoid robot 250) may be controlled to grasp and/or manipulate one or more objects to, for example, perform a pick-and-place operation within an environment such as a warehouse or automotive manufacturing facility. The robot may include a perception system (e.g., one or more cameras or other sensors), which may be used to identify attributes of an object to be grasped, such as the shape of the object and/or possible grasping locations on the object. Based, at least in part, on output from the perception system and kinematics of the robot, grasp planning may be performed to determine a grasp plan to grasp the object. A control system of the robot may then provide control commands to actuators in the robot to move the arm and/or end effector of the robot into position to grasp the object according to the grasp plan. However, errors associated with the perception system and/or the control system may result in discrepancies between the location of the object to be grasped and the location of where the robotic end effector is controlled to move prior to the grasp attempt. Such discrepancies may result in an unsuccessful and/or ineffective grasp on the object when attempted. Additionally, contact events and forces applied on a robotic end effector during manipulation of an object may be difficult to perceive by the perception system of the robot and may be too subtle to disambiguate from forces measured using force torque sensors commonly found in the wrist assembly coupled to the end effector of the robot.

The inventors have recognized and appreciated that grasping and/or manipulating an object by a robotic end effector may be improved by providing sensing capabilities on the robotic end effector which may be used to correct for sources of error introduced during grasp planning and/or execution. For example, such sensing capabilities may provide feedback to the control system to ensure that the vast majority of attempted grasps result in grasp that is strong enough and/or conformable enough to be a successful grasp. In some embodiments, one or more tactile sensors are formed on a surface of the robotic end effector to directly observe and collect high resolution information about near-contact and/or contact interactions between the robot and an object. Such information may be used to provide closed loop feedback to the control system of the robot to improve various grasping scenarios including, but not limited to, grasping an object that is visually occluded, controlling grip strength and/or force distribution on a grasped object, detecting slipping of a grasped object, regrasping an object when grasped with two robotic end effectors, and improving pre-contact approach speed and timing.

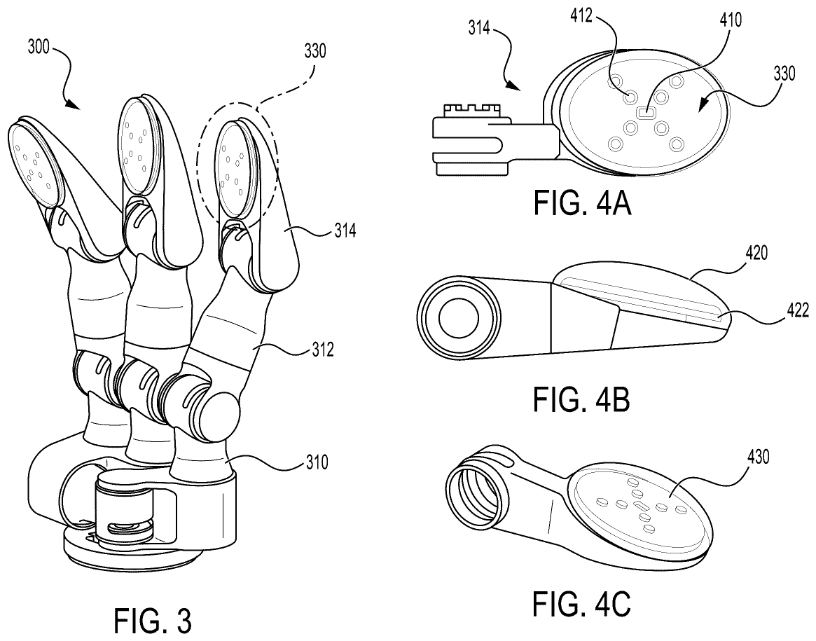

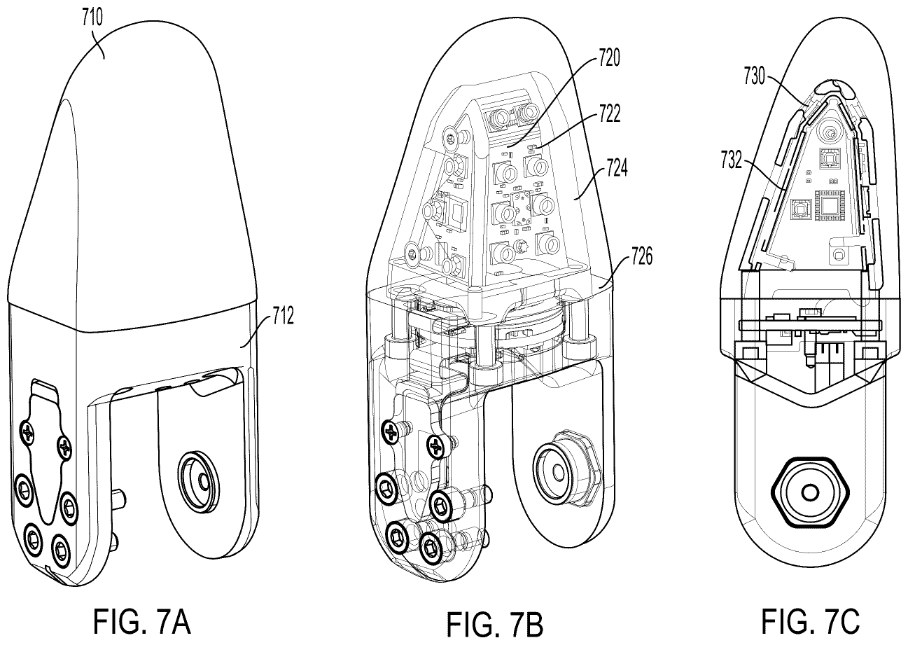

FIG. 3 is a schematic illustration of an example robotic end effector 300 having three modules (e.g., “fingers”). Each module includes a base member 310, a proximal link 312 and a distal link 314. Distal link 314 includes a tactile sensor 330 formed on a surface of the distal link. Distal link 314 may have multiple surfaces, such as a first surface (e.g., a front surface) and a second surface (e.g., a back surface) opposite the first surface. In some embodiments, in addition to a front surface and a back surface, distal link 314 may include a top surface, one or more side surfaces, etc. One or more of the surfaces of distal link 314 may include a tactile sensor. In the embodiment shown in FIG. 3, tactile sensor 330 may be disposed on a single surface (e.g., a first surface). In other embodiments, a tactile sensor may be disposed on multiple surfaces to provide additional sensing capabilities to robotic end effector 300. An example of a tactile sensor disposed on multiple surfaces is shown in FIGS. 7A-7C, described in further detail below. In such embodiments, the configuration and/or functionality of the tactile sensors disposed on each of the multiple surfaces may be the same or different.

FIG. 4A schematically illustrates a top view of a tactile sensor 330 mounted on a surface of a distal link 314, according to an embodiment of the present invention. In some embodiments, tactile sensor 330 is a multi-modal sensor that include multiple different types of sensors. For instance, tactile sensor 330 may include a proximity sensor 410 and a set of pressure sensors 412. In the example shown in FIG. 4A, the set of pressure sensors 412 are arranged in a cross pattern surrounding proximity sensor 410, which is located at the center of the tactile sensor 330. It should be appreciated that other configurations of proximity sensor 410 and pressure sensors 412 may be used. For example, although only a single proximity sensor 410 is shown, it should be appreciated that a set (e.g., one, two, three, four, or some other number) of proximity sensors 410 may alternatively be used. As another example, the set of pressure sensors 412 may include any suitable number of pressure sensors. In some embodiments, the set of pressure sensors 412 includes at least three pressure sensors that may be used to sense a force applied to a surface of tactile sensor 330.

When establishing a grasp on an object, the transition between a pre-contact state and a post-contact state may be considered a discrete and discontinuous event that may result in unexpected collisions and may lead to a weak or failed grasp (e.g., due to miscalibration errors introduced during grasp planning and/or control operations, as described above). A tactile sensor designed in accordance with the techniques described herein may smooth the transition between pre-contact and post-contact states by including multiple types of sensors configured to sense different information. For example, proximity sensor 410 may be used to sense the distance between an object to be grasped and the robotic end effector. Such distance information may be used, for example, to control the speed and/or direction of the approach of the robotic end effector to the object as it attempts the grasp on the object. In some embodiments, information from the proximity sensor 410 may be used to instruct a control system of the robot how to reorient the robotic end effector to obtain different and/or better sensor data from one or more objects in the environment. For instance, the robotic end effector may be controlled based, at least in part, on data from the proximity sensor 410 to map a shape of objects within an opaque container that the perception system of the robot cannot observe. Such information may be useful in determining which object within the container to grasp and how to grasp the object. The set of pressure sensors 412 may sense contact forces (e.g., a distribution of contact forces) on the tactile sensor 330 after the robotic end effector has contacted the object. In some embodiments, the proximity sensor 410 and the set of pressure sensors 412 may be arranged in the tactile sensor 330 such that their respective sensing regions (e.g., the spatial regions over which the sensors can sense information) overlap.

FIG. 4B schematically illustrates a side view of tactile sensor 330 shown in FIG. 4A. From the side view shown in FIG. 4B, it can be observed that the proximity sensor 410 and the set of pressure sensors 412 are formed on a substrate 422. For example, substrate 422 may be a printed circuit board (PCB). A cover 420 may be formed over the components of tactile sensor 330 to protect the components against wear and/or to provide a sensing surface that is relatively invariant due to changes in wear. As described herein, proximity sensor 410 may be configured to transmit and receive electromagnetic radiation (e.g., visible or infrared light) to detect the distance between the robotic end effector and an object to grasped. Cover 420 may comprise a material having properties that enable signals (e.g., optical signals, acoustic signals, electromagnetic signals) projected and/or received from proximity sensor 410 to propagate through the medium. For example, in some embodiments, cover 420 may include an optically translucent material that permits transmission of optical signals (e.g., laser signals) projected from proximity sensor 410 through the material. In other embodiments, proximity sensor 410 may be configured to project electromagnetic signals, and cover 420 may comprise a non-conductive material that permits transmission of the electromagnetic signals through the cover. In some embodiments, cover 420 may comprise a flexible and/or soft material such as an elastomer. The inventors have recognized that cyclical loading experienced when grasping and manipulating objects may result in cover 420 having a tendency to shear off from robotic end effector, especially when the external forces are large. To mitigate the risk that cover 420 will be damaged in this manner, at least a portion of cover 420 is configured in some embodiments to mechanically couple to substrate 422 to more firmly secure the cover 420 to the rigid structure of substrate 422. For instance, in some embodiments, at least a portion of cover 420 may mechanically couple to the substrate 422 by wrapping around at least one edge of the substrate 422.

FIG. 4C schematically illustrates an isometric view of tactile sensor 330 shown in FIGS. 4A and 4B. As shown in FIG. 4C, some embodiments include a rigid structure 430 formed between the substrate 422 and the cover 420. Rigid structure 430 may be a plate (e.g., a metal or hard plastic plate) having a set of holes formed therein to enable the proximity sensor 410 and the set of pressure sensors 412 mounted on the substrate 422 to receive sensor data. Rigid structure 430 may also provide protection against damage to the proximity sensor 410 and the set of pressure sensors 412 by providing rigidity to the overall structure of the tactile sensor 330. For example, rigid structure 430 may protect the sensors under high contact forces by providing a backstop for compression of the cover 420 and transferring the shock of the contact forces to the rigid structure 430.

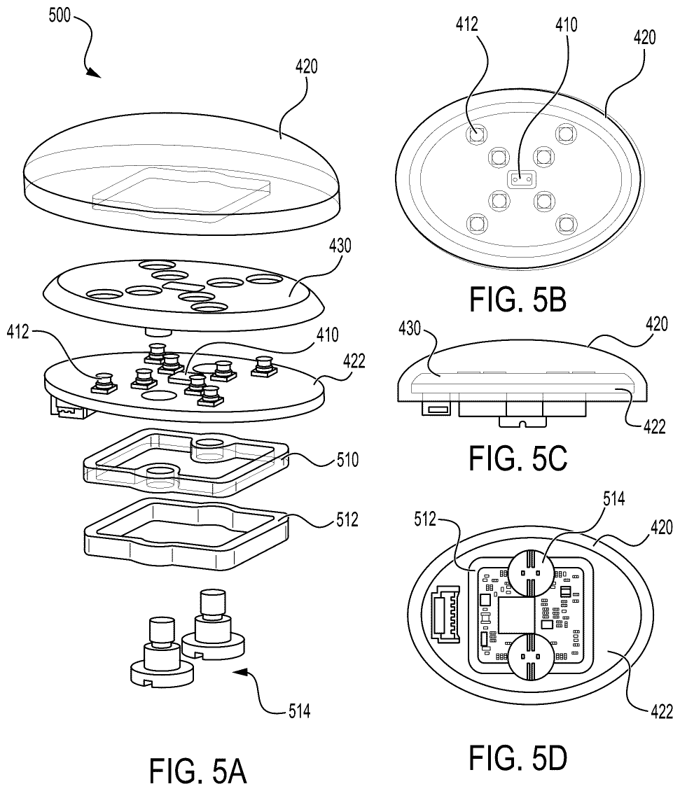

FIG. 5A schematically illustrates an exploded view of a sensor module 500 (e.g., tactile sensor 330), according to one embodiment of the present invention. As shown, sensor module 500 includes substrate 422 having formed thereon, a proximity sensor 410 and a set of pressure sensors 412. Rigid structure 430 is coupled to a top surface of substrate 422 and includes a set of holes for the proximity sensor 410 and the set of pressure sensors 412. A gasket 510 and a compression ring 512 are arranged adjacent to a bottom surface of substrate 422 and one or more fasteners 514 (e.g., screws) are used to mechanically couple substrate 422, gasket 510 and compression ring 512 to rigid structure 430. Cover 420 is formed over the coupled structure including rigid structure 430, substrate 422, gasket 510 and compression ring 512. Cover 420 may provide a sensing surface over which contact with an object may occur when grasping the object.

FIG. 5B illustrates a top view of the assembled sensor module 500 shown in FIG. 5A. As shown, the proximity sensor 410 and the set of pressure sensors 412 may be observed through the cover 420, which provides the sensing surface for the sensor module 500. FIG. 5C illustrates a side view of the assembled sensor module 500 shown in FIG. 5A. As can be observed in FIG. 5C, cover 420 may be arranged to surround one or more edges of rigid structure 430 and substrate 422. In some embodiments, the combination of cover 420 and gasket 510 form a continuous seal encapsulating substrate 422 and the sensors formed thereon. FIG. 5D illustrates a bottom view of the assembled sensor module 500 shown in FIG. 5A. Observable in FIG. 5D are compression ring 512, fasteners 514 and a bottom surface of substrate 422 which may include, for example, electronic components and memory for storing and/or processing the output of sensing components (e.g., proximity sensor 410, pressure sensors 412) coupled to substrate 422.

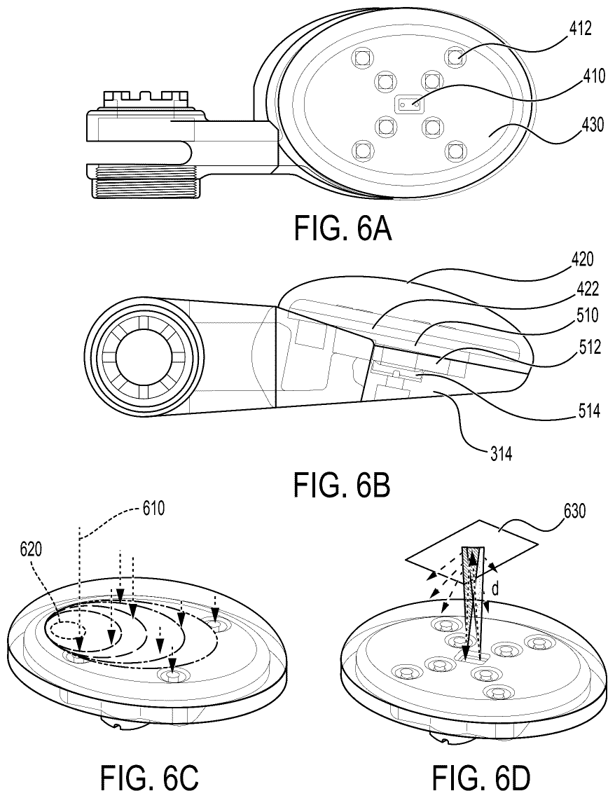

FIGS. 6A and 6B schematically illustrate respective top and side views of the sensor module 500 shown in FIG. 5A-5D mounted on a distal link 314 of a robotic end effector of a robot, according to one embodiment of the present invention. FIG. 6A shows a similar view and components as FIG. 4A explained herein, so a description will not be repeated for brevity. FIG. 6B shows a transparent side view of the distal link to which the sensor module 500 is coupled, which provides further detail relative to the side view shown in FIG. 4B. In particular, in addition to cover 420 and substrate 422, FIG. 6B also shows gasket 510 and compression ring 512. As described herein, cover 420 may protect the other components of sensor module 500 from excessive wear in addition to providing a sensing surface over which a distribution of force measurements may be made by the set of pressure sensors 412 arranged on the substrate 422. FIG. 6C shows an example force distribution 620 applied to cover 420 determined based on sensor signals received by the set of pressure sensors 412, according to an embodiment of the present invention. In FIG. 6C, dashed lines 610 represent the magnitude of forces applied at different locations on cover 420. As shown in the example of FIG. 4C, larger forces are applied to the left side of the cover 420 compared to the right side of cover 420, resulting in a force distribution that is skewed to the left. FIG. 6D schematically illustrates how proximity sensor 410 is configured to detect a distance d to an object 630 located near the sensor module. In some embodiments, to reduce multi-path effects, proximity sensor 410 may be configured to only detect distances to objects closer than a threshold distance (e.g., 100 mm) from proximity sensor 410, but not objects farther than the threshold distance.

In some embodiments that include a set of sensor modules (e.g., a robotic end effector with multiple fingers, each of which has an associated sensor module formed thereon), the set of sensor modules may be calibrated based, at least in part, on data sensed by the sensors. Such sensor calibration may help ensure that each of the sensor modules outputs the same values when exposed to the same inputs.

Additionally, the sensor calibration may be used to track and account for changes in the output of individual sensors due, for example, to wear over long periods of use.

The inventors have recognized and appreciated that repeated grasping of objects, including heavy objects, by a robotic end effector may inform the design characteristics of a tactile sensor formed on the end effector. For example, some previous human-like robotic end effectors may be designed to grasp and/or manipulate only small, lightweight objects, and as such, tactile sensors used with such robotic end effectors may not take into account sensor wear or larger forces that may be applied to the sensors over time (e.g., when used in an industrial setting), which may cause damage to the sensors if not adequately protected. In some embodiments, a tactile sensor for a robotic end effector includes components and/or configurations that enable the tactile sensor to be both sensitive to a large range of forces and also durable against damage due to, for example, large forces applied to the robotic end effector and/or wear due to repeated grasping of objects, including heavy objects.

In some embodiments, the set of pressure sensors 412 are selected to have a dynamic range capable of having sensitivity to low contact forces in addition to having the capability to resolve high contact forces without saturation (or saturating at a high level of force). For example, in some embodiments, each pressure sensor in the set of pressure sensors 412 is configured to have a dynamic range of 1-300N. In some embodiments, one or more of the pressure sensors in the set of pressure sensors 412 is configured to sense loads less than IN. In some embodiments, the set of pressure sensors 412 are implemented as barometric pressure transducers configured to detect a force applied to regions of tactile sensor 330 above the barometric pressure transducers (e.g., force applied to cover 420). When arranged as an array of pressure sensors with overlapping sensing regions, data from the set of pressure sensors 412 may be used to determine a force distribution over the surface of the tactile sensor 330, as described in connection with FIG. 6A. For example, cover 420 when implemented as an elastomer may be configured to distribute the pressure induced by contact with an object to be measured simultaneously by the set of pressure sensors 412.

In some embodiments, proximity sensor 410 and the set of pressure sensors 412 may be configured to sense data at rates that approximate continuous sensing. For example, in some embodiments proximity sensor 410 may be configured to sense distance data at a rate of at least 100 Hz and the set of pressure sensors 412 may be configured to sense data at a rate of at least 200 Hz. In some embodiments, a sensor module (e.g., sensor module 500) may include a component (e.g., one or more processors) configured to combine data sensed by proximity sensor 410 and the set of pressure sensors 412 to produce a single data stream, which may be provided to a control system of the robot. For example, such a component may be coupled to or be in communication with electronics associated with the substrate on which the proximity sensor 410 and the set of pressure sensors 412 are arranged.

In some embodiments, proximity sensor 410 may be a time of-flight sensor configured to emit and receive signals through cover 420. As described herein, cover 420 may be formed of a translucent medium (e.g., a translucent elastomer) that enables a laser signal of the time-of-flight sensor to be transmitted through the medium to detect a distance to an object. In some embodiments, proximity sensor 410 may include a radar sensor. In addition to providing a medium through which sensing can occur, cover 420 may also provide a protective function to the components of the sensor module. For example, cover 420 may be configured to mechanically couple or “interlock” with substrate 422. As described in connection with FIGS. 4B and 5C, cover 420 may be configured in some embodiments to wrap around at least one edge of the substrate 422 having the proximity sensor 410 and the set of pressure sensors 412 arranged thereon. In this way, the proximity sensor 410 and the set of pressure sensors 412 may be “embedded” in the material of cover 420, which may provide protection against damage and/or wear. In some embodiments, triply periodic minimal surfaces (TPMS) may be used to mechanically couple cover 420 and substrate 422. For instance, such TPMS surface integrated mechanical components may be created using additive manufacturing techniques. Additionally, by mechanically coupling the cover 420 to the substrate 422, the cover 420 may be less likely to shear off when exposed to high forces, which would expose the sensors to potential damage.

The inventors have recognized and appreciated that use of a flexible and/or soft material such an elastomer for cover 420 may provide other advantages with regard to wear. For instance, such a material may be more easily repaired if wear due to repeated use results in a condition that substantially degrades the performance of the tactile sensor. As an example, the damaged or worn parts of the elastomer may be partially or completely removed and a new cover 420 (e.g., all or a portion of a new cover) may be reformed over tactile sensor to restore performance.

In some embodiments, substrate 422 and the electronics formed thereon may be treated with a cold plasma prior to bonding the substrate 422 to cover 420 to improve the adhesion and bond strength between the substrate and the cover. For example, the cold plasma treatment may improve the adhesion by cleaning the surfaces by removing organic contamination prior to bonding, etching material from the surface of the substrate 422, which can remove a weak boundary layer and increase the surface area of the material available for bonding, facilitating branching of near-surface molecules, which can cohesively strengthen the surface layer of the material, and/or modifying the surface chemical structure, which can increase the surface energy of the material when re-exposed to air following the cold plasma treatment.

As described above, some embodiments include a sensor module having a proximity sensor and a set of pressure sensors, wherein the proximity sensor and the set of pressure sensors are co-located within the sensor module. As used herein, the term “co-located” describes the overlap of sensing fields rather than physical co-location of sensing components. For example, two sensors that are located at different physical locations may be considered to be co-located if they are arranged and/or configured to sense events occurring within an overlapping (partially or completely overlapping) region in space. In the example embodiments described herein, the proximity sensor and the set of pressure sensors are co-located in that both types of sensors are used to sense pre-contact and/or post-contact forces in an overlapping region of space above the sensor module (e.g., at or near to the surface of cover 420).

FIG. 7A schematically illustrates an isometric view of a tactile sensor 710 mounted on a surface of a distal link 712 of a robotic end effector, according to an embodiment of the present invention. FIG. 7B illustrates a transparent isometric view of tactile sensor 710 shown in FIG. 7A. FIG. 7C shows a transparent side view of tactile sensors 710. Similar to the embodiment shown in FIGS. 4A-4C, tactile sensor 710 shown in FIGS. 7A-7C is a multi-modal sensor that include multiple different types of sensors. For instance, tactile sensor 710 includes a set of pressure sensors 730 and a set of proximity sensors 732. Rather than being arranged on a single surface, the set of pressure sensors 730 and the set of proximity sensors 732 are arranged on multiple surfaces to sense in multiple directions. As shown in FIGS. 7B and 7C, the inclusion of sensors on multiple surfaces of a robotic end effector may permit the number of sensors to be increased compared with a tactile sensor that includes sensors on a single surface. For instance, the example tactile sensor 710 shown in FIGS. 7A-7C includes twenty-two pressure sensors 730 arranged on four different surfaces (front, back, left and right sides) and two proximity sensors 732 arranged on two different surfaces (front, back). A single proximity sensor 732 is arranged at a center of the front surface and the back surface of tactile sensors 710. The set of pressure sensors 730 are arranged around the proximity sensors 732 and are configured to sense forces applied to a surface of tactile sensor 710. For instance, the set of pressure sensors 730 includes eight pressure sensors arranged on a front surface, eight pressure sensors arranged on a back surface, and three pressure sensors arranged on each of the right and left side surfaces.

As shown in FIG. 4B, it can be observed that in some embodiments, the set of pressure sensors 730 and the set of proximity sensors 732 are formed on a first substrate 720. For example, first substrate 720 may be a flexible printed circuit board (PCB) that may be folded and secured to a tactile sensor scaffold to provide rigidity to the tactile sensor 710. A cover 724 may be formed over the components of tactile sensor 710 to protect the components against wear and/or to provide a sensing surface that is relatively invariant due to changes in wear. As described herein in connection with the embodiment shown in FIGS. 4A-4C, the set of proximity sensors 732 may be configured to transmit and receive electromagnetic radiation (e.g., visible or infrared light) to detect the distance between the robotic end effector and an object to grasped. Cover 724 may comprise a material having properties that enable signals (e.g., optical signals, acoustic signals, electromagnetic signals) projected and/or received from the set of proximity sensors 732 to propagate through the medium. For example, in some embodiments, cover 724 may include an optically translucent material that permits transmission of optical signals (e.g., laser signals) projected from the set of proximity sensors 732 through the material. In other embodiments, the set of proximity sensors 732 may be configured to project electromagnetic signals, and cover 724 may comprise a non-conductive material that permits transmission of the electromagnetic signals through the cover. In some embodiments, cover 724 may comprise a flexible and/or soft material such as an elastomer.

As shown in FIG. 7B, tactile sensor 710 includes a rigid structure 722 formed between the first substrate 720 and the cover 724. Rigid structure 722 may be a plate (e.g., a metal or hard plastic plate) having a set of holes formed therein to enable the set of proximity sensors 732 and the set of pressure sensors 730 mounted on the first substrate 720 to receive sensor data. Rigid structure 722 may also provide protection against damage to the set of pressure sensors 730 and the set of proximity sensors 732 by providing rigidity to the overall structure of the tactile sensor 710. For example, rigid structure 722 may protect the sensors under high contact forces by providing a backstop for compression of the cover 724 and transferring the shock of the contact forces to the rigid structure 722. In some embodiments, rigid structure 722 may comprise multiple pieces configured to couple (e.g., lock) together when assembled. Observable in FIG. 7B, first substrate 720 and/or the sensors formed thereon may be coupled to a second substrate 726, which may include, for example, electronic components and memory for storing and/or processing the output of sensing components (e.g., set of pressure sensors 730, set of proximity sensors 732) coupled to the first substrate 720.

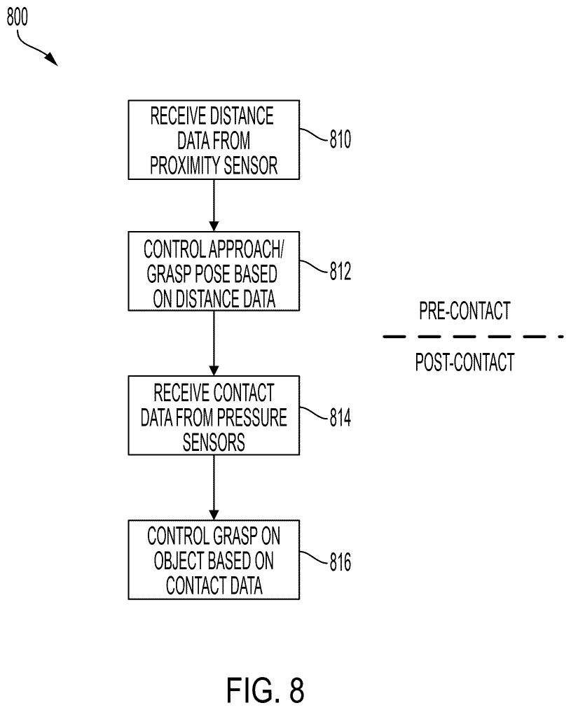

When establishing a grasp on an object with a robotic end effector, the transition from a pre-contact state and a post-contact state between the robotic end effector and the object is a discrete and discontinuous event that can result in unexpected collisions and lead to a weak or failed grasp. In some embodiments, proximity sensing is used to sense pre-contact information about an object to be grasped, and the pre-contact information can be used to control the approach of the robotic end effector to the object. Control during the pre-contact phase using feedback from a proximity sensor arranged on the robotic end effector may smooth the discrete transition between the pre-contact and post-contact phases. FIG. 8 is a flowchart of a process 700 for controlling a robotic end effector based on feedback from a sensor module (e.g., sensor module 500 shown in FIG. 5A), according to an embodiment of the present invention. Process 800 begins in act 810, where distance data is received from a proximity sensor on a robotic end effector. As described herein, a tactile sensor arranged on a robotic end effector may include a proximity sensor configured to detect a distance between the robotic end effector and an object in close proximity (e.g., 100 mm or less) to the robotic end effector. Process 800 then proceeds to act 812, where the approach and/or grasp pose of the robotic end effector is controlled based, at least in part, on the distance data. As described above, errors in positioning of the robotic end effector relative to a desired grasp position on an object may result in a discrepancy between a location where the robotic end effector is controlled to move and the actual location of the object be grasped. Feedback provided by the distance data sensed by the proximity sensor enables for correction of such a discrepancy by fine tuning the approach of the robotic end effector to the object when the object is close but not yet in contact with the robotic end effector. Making such corrections may enable for a more reliable and/or secure grasp of the object when the grasp is attempted.

Process 800 then proceeds to act 814, where contact data is received from the set of pressure sensors. When the proximity sensor senses that the distance to the object becomes zero or close to zero and contact between the robotic end effector and the object is detected using the set of pressure sensors, a smooth transition between a pre-contact phase of the grasp and a post-contact phase of the grasp occurs. As described herein, the contact data from a set of pressure sensors may be processed and a force distribution map (e.g., as shown in FIG. 6C) describing the force distribution on the sensing surface of the tactile sensor may be determined. Process 800 then proceeds to act 816, where the grasp on the object is controlled based, at least in part, on the contact data. The grasp may be controlled in any suitable way. For example, the initial contact determination may initiate a grasp attempt sequence in which the fingers of the robotic end effector wrap around the object to be grasped. As more contact data is received as additional tactile sensors come into contact with the object, the grasp position and/or forces applied by various fingers of the robotic end effector may be modulated until a secure grasp is achieved.

The inventors have recognized and appreciated that tactile sensing with proximity and pressure sensors on a robotic end effector that has grasped an object, as described herein, may facilitate manipulation of the object while the object is grasped, also referred to herein as “dynamic grasping.” For instance, contact data that measures the force distribution of the object on the tactile sensor surface of multiple tactile sensors corresponding to different fingers a robotic end effector may be used to control the fingers or other robotic links of the robot to perform “in-hand” manipulation of the object. In-hand manipulation of the robot may include, but is not limited to, shifting the position of the object within the robotic end effector, transferring the object from a first robotic end effector to a second robotic end effector, and coordinating the grasp between multiple robotic end effectors when a multiple end effector technique is used to grasp the object.

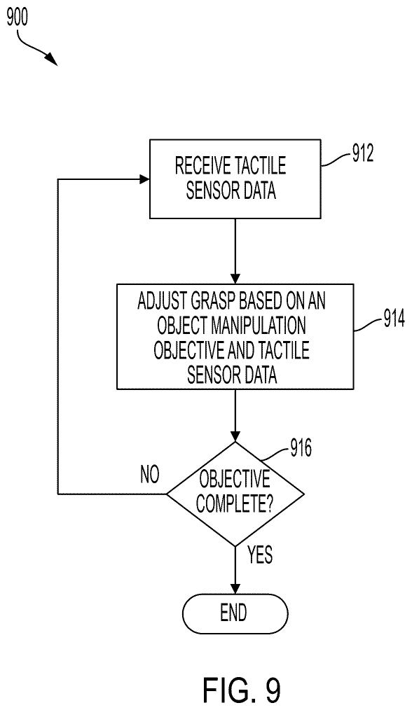

FIG. 9 illustrates a process 900 for dynamic grasping based on tactile sensor feedback, in accordance with an embodiment of the present invention. Process 900 begins in act 912, where tactile sensor data is received from one or more tactile sensors arranged on a robotic end effector of a robot. In some embodiments, the tactile sensor data may include distance data sensed by one or more proximity sensors, contact data sensed by one or more pressure sensors, or both distance data and contact data. For instance, for a first tactile sensor arranged on a first finger of a robotic end effector, the received tactile sensor data may correspond to either first distance data (if the first finger is not in contact with the object) or first contact data (if the first finger is in contact with the object). For a second tactile sensor arranged on a second finger of the robotic end effector, the received tactile sensor data may correspond to second distance data (if the second finger is not in contact with the object) or second contact data (if the second finger is in contact with the object). The received tactile sensor data may also include distance data and/or contact data from tactile sensors arranged on other modules (e.g., fingers) of the robotic end effector or on an additional robotic end effector.

Process 900 then proceeds to act 914, where the grasp on the object is adjusted based, at least in part, on an object manipulation objective and the received tactile sensor data. Examples of object manipulation objectives include, but are not limited to, maintaining a specified contact state on the object, shifting the position of the object within the robotic end effector, transferring the object from a first robotic end effector to a second robotic end effector, coordinating the grasp between multiple robotic end effectors when a multiple end effector technique is used to grasp the object, lifting the object, releasing the grasp of the object, and placing the object in a particular location (e.g., sliding the object into a slot).

The tactile sensor data received from the tactile sensor(s) may provide feedback during object manipulation to facilitate successful completion of the object manipulation objective. For instance, process 900 may proceed to act 916, where it is determined whether the object manipulation objective has been completed. If it is determined in act 916 that the object manipulation objective has not yet been completed, process 900 returns to act 912, where additional tactile sensor data is received, and acts 912-914 are repeated until it is determined in act 916 that the object manipulation objective has been completed, after which process 900 ends.

In some embodiments, the tactile sensor data may be used to detect slippage of an object in the grasp of the robotic end effector. Corrective actions to re-establish the grasp in the event of detected slippage may be performed to mitigate the risk that the object will be dropped. In some embodiments, the time variability of the pressure distribution sensed by the set of pressure sensors may be used to detect the onset of slipping events at that contact point. For example, the contact signal received from the pressure sensors may be decomposed into high and low frequency components using a technique such as a discrete wavelet transform. The high frequency signal characteristic may be compared to a threshold over time to detect a slipping event.

In some embodiments, the tactile sensor data is continuously received as the object is manipulated according to the object manipulation objective. It should be appreciated that as the object is manipulated, the type of data being sensed by a particular tactile sensor may change as one or more tactile sensors contact or are released from contact with the object. For instance, consider an example in which an object is grasped between two opposed fingers of a robotic end effector (e.g., using a pinch grasp) having three fingers. The object manipulation objective may be to regrasp the object using a different set of two fingers of the robotic end effector than are currently grasping the object without dropping the object. To achieve this object manipulation objective, the robotic end effector may be controlled to contact the object with all three fingers of the robotic end effector and then release one of the fingers used in the original pinch grasp. When determining how to contact the third finger on the object, first contact data from a first tactile sensor on the first finger and second contact data from a second tactile sensor on the second finger may be used to determine (e.g., based on one or more force distributions) how to shift the object between the first and second fingers to enable the third finger to contact the object. Distance data from a third tactile sensor on the third finger may be used to determine how to approach the object during its pre-contact phase. After contacting the object, third contact data from the third tactile sensor may be used, at least in part, to determine how to shift the object between the first, second and third fingers to position the object between the first and third fingers such that the second finger can be released from the object. After shifting the object between the first and second fingers, distance data from the second tactile sensor may be used in combination with the first contact data and the third contact data to control the second finger to release from the object, with the result being the object pinched between the first and third fingers.

Although the dynamic grasping example described above is for object manipulation using fingers of a single end effector, it should be appreciated that the techniques described herein for performing dynamic grasping based, at least in part, on tactile sensor data may be extended to manipulation of objects using multiple robotic end effectors.

A number of implementations have been described. Nevertheless, it will be understood that various modifications may be made without departing from the spirit and scope of the disclosure.

1. A sensor module for an end effector of a robot, the sensor module comprising:
a substrate having formed thereon, a set of proximity sensors and a set of pressure sensors, the set of proximity sensors and the set of pressure sensors configured to have overlapping sensing regions; and
a cover coupled to the substrate, the cover comprising a material that permits transmission of signals from the set of proximity sensors through the material.

2. The sensor module of claim 1, further comprising:
a rigid structure formed between the substrate and the cover.

3. The sensor module of claim 2, wherein the rigid structure comprises a plate having holes formed therein for the set of proximity sensors and the set of pressure sensors.

4. The sensor module of claim 3, wherein the rigid structure comprises a metal structure.

5. The sensor module of claim 1, wherein at least a portion of the cover is mechanically coupled to the substrate.

6. The sensor module of claim 5, wherein the at least a portion of the cover wraps around an edge of the substrate.

7. The sensor module of claim 1, wherein the cover comprises an elastomer.

8. The sensor module of claim 1, wherein the set of proximity sensors comprises at least one time-of-flight sensor.

9. The sensor module of claim 1, wherein the set of pressure sensors comprises a set of barometric transducers.

10. The sensor module of claim 1, wherein
the set of proximity sensors includes a single proximity sensor, and
the set of pressure sensors includes at least four pressure sensors arranged adjacent to the single proximity sensor.

11. The sensor module of claim 1, wherein the set of pressure sensors is configured to provide a distribution of contact pressure on the cover when in contact with an object.

12. The sensor module of claim 1, wherein the set of pressure sensors is configured to sense contact data at a rate of at least 200 Hz.

13. The sensor module of claim 1, wherein the set of proximity sensors is configured to sense distance data at a rate of at least 100 Hz.

14. The sensor module of claim 1, further comprising a component configured to combine contact data from the set of pressure sensors and distance data from the set of proximity sensors to produce a single data stream.

15. The sensor module of claim 1, wherein the substrate comprises a printed circuit board.

16. The sensor module of claim 1, wherein
the set of proximity sensors is configured to project optical signals, and
the cover comprises an optically translucent material.

17. The sensor module of claim 1, wherein
the set of proximity sensors is configured to project electromagnetic signals, and
the cover comprises a non-conductive material.

18. The sensor module of claim 1, wherein a dynamic range of each pressure sensor in the set of pressure sensors is 1-300N.

19. An apparatus for a robot, the apparatus comprising:
a base; and
at least two modules coupled to the base, each module comprising a proximal link and a distal link coupled to the proximal link,
wherein each of the distal links includes a sensor module, the sensor module comprising:
a substrate having formed thereon, a set of proximity sensors and a set of pressure sensors, the set of proximity sensors and the set of pressure sensors configured to have overlapping sensing regions; and
a cover coupled to the substrate, the cover comprising a material that permits transmission of signals from the set of proximity sensors through the material.

20. A method of grasping an object with a robotic end effector, the method comprising:
receiving distance data from a set of proximity sensors mounted on the robotic end effector, wherein the distance data indicates a distance between the set of proximity sensors and the object;
controlling the robotic end effector to approach the object based, at least in part, on the received distance data;
receiving contact data from a set of pressure sensors mounted on the robotic end effector, the set of pressure sensors configured to have an overlapping sensing region with the set of proximity sensors; and
controlling the robotic end effector to grasp the object based, at least in part, on the received contact data.
